(19) United States
(12) Patent Application Publication
(10) Pub. No.: US 2004/0111722 A1
(43) Pub. Date: Jun. 10, 2004

(54) Remote control system for locomotives using a networking arrangement

(75) Inventors: Folkert Horst, Pierrefonds (CA); Oleh Szklar, St-Hubert (CA); Stephan P. Georgiev, St-Hubert (CA); Brigide Mattar, Ville Mont-Royal (CA)

Correspondence Address: DARBY & DARBY P.C., P. O. BOX 5257, NEW YORK, NY, 10150-5257, US

(73) Assignee: CANAC INC., St-Laurent (CA)

(21) Appl. No.: 10/727,932

(22) Filed: Dec. 2, 2003

Related U.S. Application Data
(60) Provisional application No. 60/430,093, filed on Dec. 2, 2002.

(51) Int. Cl. G06F 9/44

(52) U.S. Cl. 717/168; 717/100; 717/104

(57) ABSTRACT

A network entity for remotely controlling a plurality of locomotive entities. The network entity has two main components, namely a communications layer for communicating simultaneously via a set of radio frequency (RF) communication links with respective remote transmitters and respective locomotive entities, and an intelligence layer for processing data derived from signals received by the communications layer from the RF communication links.

### CROSS-REFERENCE TO RELATED APPLICATIONS

This application claims the benefit of U.S. provisional application Serial No. 60/430,093 filed Dec. 2, 2002. The contents of the above ducment are incorporated herein by reference.

### FIELD OF THE INVENTION

This invention relates to the field of communication and control systems. It is particularly suitable to a method and apparatus for remotely controlling locomotives.

### BACKGROUND OF THE INVENTION

Electronic controllers are commonly used in the industry to regulate the operation of a wide variety of systems. In a specific example, electronic controllers are used to remotely control vehicles such as locomotives in order to perform functions including braking and acceleration without the necessity of a human operator on board the locomotive. Radio frequency transmitter-receiver pairs are of particular interest for remotely controlling such vehicles. In a typical locomotive control system, the operator uses a remote control device to communicate with a trail controller located onboard the locomotive. The remote control device includes an electronic circuit placed in a suitable casing that provides mechanical protection to the electronic components.

In use, the operator of the locomotive enters requests into the remote control device via an input means such as switches, a keyboard, a touch sensitive screen or any other suitable input means. Typical requests may include braking, accelerating and any other function that a locomotive may be required to perform. The remote control device encodes the request into a form suitable for transmission over a given communication link. The complete request is then modulated at a predetermined radio frequency and transmitted as an RF signal. Frequencies other than RF have also been used for this purpose. The trail controller onboard the locomotive then receives and demodulates the RF signal originating from the remote control unit. Optionally, the trail controller onboard the locomotive may also transmit information back to the remote control unit. In such a case, the trail controller encodes the request into a form suitable for transmission over a given communication link. The complete request is then modulated at a pre-determined radio frequency and transmitted as an RF signal. The remote control unit is equipped with a receiver to receive and demodulate the RF signal originating from the trail controller.

Class I railroads in the United States have begun a rapid deployment of remote control technology. As such, there are often multiple locomotives within a certain region being controlled remotely. A deficiency with such systems is that the operators controlling the remote control units are unaware of what each other are doing. This can lead to dangerous situations because there is the potential for two operators to be controlling their respective locomotives in a manner that will result in a collision course, or some other form of damage, due to the fact that each operator is unaware of what the other operator is doing.

As such, there exists a need in the industry for an improved method and apparatus for controlling a plurality of locomotive entities.

### SUMMARY OF THE INVENTION

In accordance with a broad aspect, the invention provides a network entity for remotely controlling a plurality of locomotive entities. The network entity has two main components, namely a communications layer for communicating simultaneously via a set of radio frequency (RF) communication links with respective remote transmitters and respective locomotive entities, and an intelligence layer for processing data derived from signals received by the communications layer from the RF communication links.

In accordance with another broad aspect, the invention provides a network entity for remotely controlling a plurality of locomotive entities. The network entity comprises a communication layer and an intelligence layer. The communication layer is operative for communicating simultaneously via a set of RF communication links with respective remote transmitters and respective locomotive entities. The intelligence layer is operative for communicating with the communication layer. The intelligence layer is capable of acquiring at least a first and a second mode of operation. In the first mode of operation, the intelligence layer allows commands issued from the transmitters and conveyed via respective RF communication links to be transmitted to the respective locomotive entities via respective RF communication links. In the second mode of operation, the intelligence layer is operative to send to one or more transmitters via respective RF communication links data to allow the one or more transmitters to perform a software upgrade.

### BRIEF DESCRIPTION OF THE DRAWINGS

A detailed description of examples of implementation of the present invention is provided hereinbelow with reference to the following drawings, in which:

FIG. 1 is a block diagram of a remote control system for locomotives using a networking arrangement, according to the present invention;

FIG. 2 is a more detailed block diagram of some components of the system shown in FIG. 1.

In the drawings, embodiments of the invention are illustrated by way of example. It is to be expressly understood that the description and drawings are only for purposes of illustration and as an aid to understanding, and are not intended to be a definition of the limits of the invention.

### DETAILED DESCRIPTION

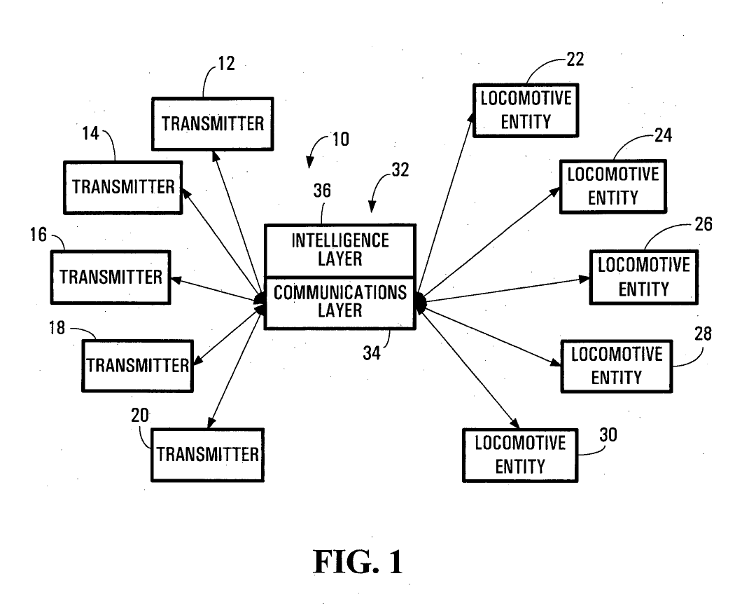

FIG. 1 illustrates a remote control system for a plurality of locomotive entities, designated comprehensively by 10. The system 10 includes a plurality of transmitters 12-20 that control respective locomotive entities 22-30. Normally, each transmitter is carried by a human operator that is responsible for a given locomotive entity. The operator selects commands or functions from the user interface on the transmitter 12-20 which are communicated to the respective locomotive entity 22-30 where they are implemented. Examples of commands include an acceleration command to cause the locomotive entity to move and a brake command to cause the locomotive entity to brake.

In a specific example of implementation, the transmitters 12-20 are portable units that are adapted for being carried by a human operator located remotely from the locomotive entities 22-30. It should however be understood that in an alternative example of implementation, the transmitters 12-20 can be stationary units that are mounted at a remote location from the locomotive entities 22-30, such as in a control tower or in an operator station.

The remote control system 10 also includes a network entity 32 via which commands sent from the transmitters 12-20 to respective locomotive entities 22-30 are channeled. The system 10 can be designed with a unidirectional communication capability where transmitters 12-20 can only send commands to the respective locomotive entities 22-30. Alternatively, the system can be provided with a bi-directional communication capability where the locomotive entities 22-30 send information to the network entity 32 or to respective transmitters 12-20. In the case where the transmitters 12-20 have bi-directional capability, such that they are able to receive signals from the locomotive entities 22-30, they have receiver capabilities. In one embodiment, the remote transmitters 12-20 may in fact be remote transceivers. In the latter case, the information is channeled via the respective RF communication links and passes through the network entity 32.

The nature of the RF communication links established between the transmitters 12-20, the locomotive entities 22-30 and the network entity 32 can vary greatly without departing from the spirit of the invention. One possible example is to use RF communication links that operate on different frequencies. In other words, each RF communication link is assigned its own frequency. The frequency spacing between adjacent RF communication links is selected to provide the desired bandwidth in accordance with the intended application. Another example is to use a spread spectrum technology where all the transmitters 12-20 and locomotive entities 22-30 operate within the same frequency band where the respective transmissions are uniquely coded such that they can be distinguished from one another. Yet another possibility is to use a time division multiple access (TDMA) arrangement that assigns time slots to respective transmitters 12-20 and locomotive entities 22-30 within a common frequency band. The reader skilled in the art will appreciate that the invention is not limited to these examples and other communication arrangements can be devised without departing from the spirit of the invention.

The network entity 32 has two main components, namely a communications layer 34 and an intelligence layer 36. The communications layer 34 globally designates the various components of the network entity 32 that collectively provide the network entity 32 with a communication function. Such components include hardware components and optionally software components. Examples of such hardware components include antennas, modulators, demodulators, etc.

In a specific example, when a TDMA communication arrangement is used, the communications layer 34 provides time slot assignment functionality. More specifically, the communications layer 34 determines which time slot will be used by which entity (locomotive entities 22-30 or transmitters 12-20). In this manner, each entity (locomotive entities 22-30 or transmitters 12-20) uses a separate time slot, thus avoiding conflicts. In addition to time slot assignment, the communications layer 34 may also send to each entity (locomotive entities 22-30 or transmitters 12-20) timing information if those entities have no proper time references.

The intelligence layer 36 performs processing of data derived from the signals received by the communications layer 34 from the transmitters 12-20 and, optionally from the locomotive entities 22-30 in the case the system 10 has a bi-directional communication capability. The intelligence layer 36 may perform a wide variety of functions, some of which will be discussed later.

The intelligence layer 36 can be implemented in software, hardware or a combination of software and hardware.

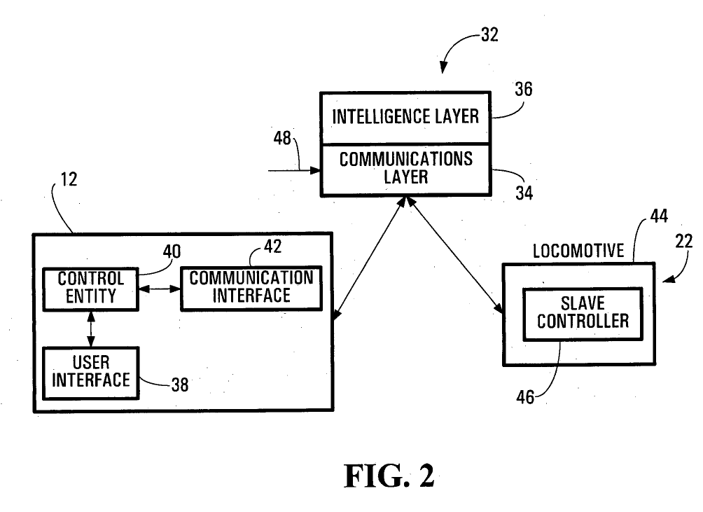

FIG. 2 is a block diagram that illustrates in greater detail the structure of a transmitter 12 and the structure of the locomotive entity 22. The transmitter 12 includes a user interface 38. The operator communicates with the transmitter 12 via the user interface 38. Stated otherwise, the operator enters commands to be implemented by the locomotive entity 22 via the user interface 38. If transmitter 12 is designed to communicate information back to the operator such information is also communicated via the user interface 38. Examples of components of the user interface 38 include manually operated switches, a keyboard, a touch sensitive screen, pointing devices, voice recognition, display screen, and a speech synthesizer, among others. The transmitter 12 also includes a control entity 40. The control entity 40 provides the main controlling function of the transmitter 12. The control entity 40 can be implemented in hardware, in software or as a combination of hardware and software. The transmitter 12 further includes a communication interface 42 via which the transmitter 12 communicates with the network entity 32 over the RF communication link. Communication paths connect the user interface 38, the communication interface 42 and the control entity 40 to allow internal signals to be exchanged between those components.

The locomotive entity 22 is a combination of two components namely a locomotive 44 and a slave controller 46 mounted on board the locomotive. It is the slave controller 46 that communicates via the RF communication link with the network entity 32 and receives via that RF communication link the commands issued by the transmitter 12. The slave controller 46 interfaces with the various locomotive controls in a known manner such as to implement those commands.

The intelligence layer 36 can provide a variety of functions and services. A first example is to analyze the various commands sent by the transmitters 12-20 and modify one or more of those commands according to built-in logic. This functionality provides the ability for the network entity 32 to manage the operation of the locomotive entities 22-30 on a global scale.

In one specific example, the built-in logic is designed to provide collision avoidance functionality. Consider a scenario where two locomotive entities 22-30 are converging, their respective operators being unaware of the hazardous situation. The intelligence layer 36 receives commands sent from the respective transmitters 12-20. For the sake of this example, assume that each transmitter 12-20 commands to the respective locomotive entity 22-30 to more forward at a certain speed. The intelligence layer 36 also receives from the respective locomotive entities positional information that may be obtained from a global positioning system (GPS) receiver on each locomotive entity 22-30. Each locomotive entity 22-30 constantly sends the position reported by its GPS receiver to the intelligence layer 36 via its RF communication link. When the built-in logic of the intelligence layer 36 senses that collision is likely, it will alter commands received from one or both transmitters 12-20 to produce modified commands that are sent to the respective locomotive entities 22-30 to prevent the collision. The modified command can be any command that the built-in logic chooses to resolve the hazardous condition. Examples include directing one or both locomotive entities 22-30 to alter their speed, apply emergency brakes, and alter their direction of movement, among many others.

It should be noted that the positional information does not need to be provided by the locomotive entities 22-30 themselves; implementations where the positional information is obtained from sources other than the locomotive entities 22-30 are possible. Examples include position sensors on the tracks that communicate to the network entity 32, via a separate communication link which may be wireless or of the wire-based type, the position of each locomotive entities 22-30. In FIG. 2 the arrow 48 shows this separate communication link.

The same principle also applies to avoidance of collisions with fixed objects rather than moving objects. Another possible variant is to use this functionality to establish boundary limits on the track that the locomotive entities 22-30 will not cross. Thus, if the intelligence layer 36 detects that the locomotive entities 22-30 traveling on the track have passed beyond or likely to pass beyond a certain point defined as a boundary, it issues a modified command to cause the locomotive entities 22-30 to stop. Yet another possible application is to use this functionality to prevent an operator carrying a transmitter 12-20 from being injured by the moving locomotive entities 22-30. In such application, each transmitter 12-20 is provided with a GPS receiver that constantly reports its position to the intelligence layer 36 via the respective RF communication link. If at any time, the intelligence layer 36 senses that an operator is in a position such that it may be hit by the moving locomotive entities 22-30 or by the locomotive entities 22-30 that are stationary but have received the command to move, then the intelligence layer 36 will modify one or more commands to prevent an accident from happening. Examples include directing the locomotive entities 22-30 to stop, sounding a horn on the locomotive entities 22-30 to warn the operator that he is at risk, or any other appropriate action.

Another functionality that may be provided by the intelligence layer 36 is to perform data collection such as to create a log of the various operations/activities in a switching yard in which the system 10 is installed. The intelligence layer 36 collects data from the various commands sent from the transmitters 12-20 and organizes this data in any suitable way defined by the switching yard operator. This may include, for example, what kinds of operations were performed by every locomotive entities 22-30 over a period of time such as a day, a week or month, how long the locomotive entities 22-30 have remained idle during the period, any hazardous conditions encountered, etc.

Another possible function that the intelligence layer 36 can provide is the control of auxiliary devices. Auxiliary devices are devices that are separate from the locomotive entities 22-30. A specific example of an auxiliary device is a railroad switch. To allow the locomotive entities 22-30 to reach their intended destination, the operator may need to set one or more railroad switches in a certain position. Under the present invention, this may be accomplished directly from the transmitter 12-20. The user interface 38 provides the ability for the operator to enter commands to set one or more railroad switches to desired positions. Those commands are encoded by the control entity 38 and sent via the RF communication link to the network entity 32. In turn, the network entity 32 passes the command to the one or more railroad switches (not shown) via a communication channel (not shown) that can be of wireless nature or wire-based. In this scenario, the intelligence layer 36 is able to distinguish between the commands directed to the locomotive entities 22-30 and commands directed to auxiliary devices, and consequently direct those commands to their respective destinations. A possible refinement that can also be considered is the ability of the intelligence layer 36 to provide an arbitration function such as to avoid that a railroad switch set in a certain position by one operator is inadvertently set to a different position by another operator. When a certain operator wishes to set the position of a railroad switch, the first step is to request control of that railroad switch to the network entity 32. If the railroad switch is not under the control of another operator, control of the railroad switch is granted to the requester and, at this point, the intelligence layer 36 will recognize commands only from the operator to whom control has been granted. Commands coming from other transmitters 12-20 will not be executed. As mentioned earlier, the remote control system 10 can be provided with a bi-directional communication capability such that the intelligence layer 36 can provide to the various transmitters 12-20 feedback information as to whether the control status has been granted or denied, whether a command has been accepted or rejected, etc.

Yet another example of functionality that the intelligence layer 36 can provide is to allow an operator on any one of the transmitters 12-20 to communicate with any other entity that is in communication with the network entity 32. Such other entity can be another transmitter 12-20, a locomotive entity 22-30 or any other device connected via a wireless communication channel or a wire-based communication channel to the network entity 32. The communication is effected by sending a media signal from the originating transmitter 12-20 to the network entity 32 over the respective RF communication link. The intelligence layer 36 provides a switching function that will switch the media signal from the incoming RF communication link over the outgoing RF communication link leading to the destination entity. The media signal includes audio data and may also include video data if the bandwidth of the RF communication links is sufficient.

This function can be implemented as follows. Each transmitter 12-20 is provided with a user interface 38 that can accept audio information via a microphone and optionally video information via a suitable camera. In addition to these inputs, the user interface 38 also allows the operator to select the destination of the media signal. The destination can be another transmitter 12-20, a locomotive entity 22-30 or any other device connected to the network 32 either directly or indirectly. By “indirect connection” is meant a connection realized over several hops in the network. Once the operator selects the destination, he or she inputs audio or video information that is digitized and preferably encoded to reduce bandwidth requirements. The resulting digital media signal is transported over the RF communication link simultaneously with the commands sent to the locomotive entity 22-30. One specific example is to organize all the information sent from the transmitter 12-20 in frames where at least one field of a frame is reserved for the media signal, one for the destination address (the entity to which the media signal is destined) and one or more fields carry commands. The reader skilled in the art will appreciate that many other possibilities exist to combine these two types of information and transport them simultaneously over the same RF communication link, without departing from the spirit of the invention. When the media signal is delivered to the intelligence layer 36, the intelligence layer 36 will determine the destination of the media signal, based on the destination address information, and switch the media signal accordingly.

The transmission of video information can be from locomotive entities 22-30 to transmitters 12-20 and can be useful for protecting the point of movement, when the locomotive entities 22-30 are moving and the operator does not have a clear sight of the what is ahead of the locomotive entities 22-30 or train. The video information produced by a suitable camera on the locomotive entities 22-30 and sent to the transmitters 12-20 allows the operator to see ahead of the locomotive entities 22-30 or the train.

Another possible function that can be performed by the intelligence layer 36 is to drive informational displays on the respective transmitters 12-20. In this embodiment, each or some of the transmitters 12-20 have displays on which information can be delivered. The intelligence layer 36 sends to the transmitters 12-20 having informational displays the data containing the information to be displayed. The information to be displayed can vary greatly. One example is to send to the informational displays a map identifying certain features that could be useful to the operator, for instance the location of the locomotive entities (22-30) controlled by the operator and optionally the location of the other locomotive entities (22-30) operating in the yard. This feature can be implemented by providing each locomotive entities (22-30) with a GPS receiver where each locomotive entities (22-30) sends to the intelligence layer 36 over the respective RF communication link information identifying the position of the locomotive entities 22-30. The intelligence layer 36 sends to each transmitter 12-20 over the respective communication link graphic info allowing the informational display to show a map and in addition data allowing to display the position of each locomotive entities 22-30 on the map. The information can be sent via frames, where one or more fields of the frame are loaded with the graphic info and the data identifying the position of the various locomotive entities 22-30.

Another example is to send to the transmitters 12-20 information on the map shown in the information display about boundaries that should not be crossed by the respective locomotive entities 22-30 controlled by the operator. The operator can instantly see how close the locomotive entities 22-30 are with relation to the boundary. Since the process of sending the information to the respective transmitters 12-20 is of dynamic nature, the updates can be made as required. In the case of positional information of the locomotive entities 22-30, updates are sent to the transmitters 12-20 at respective time intervals or when the position of one or more locomotive entities 22-30 has changed. In the case of boundaries, updates can also be made when a boundary changes.

Yet another example is to send to the various informational displays, data identifying conditions of auxiliary devices, such as railroad switches and/or whether they are under the control of another operator.

Yet another possible function, which may be performed by the intelligence layer 36, is to arbitrate between different transmitters 12-20 for the control of a single locomotive entity 22-30. It is known in the area of remote control systems for to alternative between multiple transmitters for the control of a locomotive entity. At any given time, only one of the transmitters has the authority to control the locomotive, except for emergency commands, such as applying brakes, which are accepted from both transmitters. With the remote control system 10 under the present invented concept, the intelligence layer 36 makes the decision as to which transmitter 12-20 will be holding the control authority. This feature allows expanding the number of transmitters that can acquire the control authority to three or more. The procedure to switch the control authority from one transmitter 12-20 to another involves first entering a request through the user interface 38 of the transmitter 12-20 that requests the control authority which, in turn outputs a signal over the RF communication link, which is delivered to the network entity 32. The intelligence layer maintains a register of the transmitters 12-20 that are allowed to hold the control authority and also of the specific transmitter 12-20 that currently has been assigned the control authority. If no transmitter 12-20 currently holds the control authority, the requesting transmitter 12-20, assuming it is allowed to acquire the control authority, is automatically granted that authority. At this point, commands issued from the transmitters 12-20 that hold the control authority will be recognized and accepted and passed to the locomotive entities 22-30.

If a different transmitter 12-20 wishes now to acquire the control authority, that transmitter 12-20 issues a request as described above, to the network entity 32. Once the request arrives, the intelligence layer sends a signal to the transmitter 12-20 that currently holds the control authority to ask permission for switching the control authority. If the operator accepts to relinquish the control authority by entering a confirmation on the user interface 38, the intelligence layer 36 will now assign the control authority to the requesting transmitter 12-20 and will from now on accept commands only from that transmitter 12-20. This arrangement also allows the intelligence layer to perform automatic switching of the control authority when a transmitter 12-20 that currently holds the control authority is no longer able to adequately control the locomotive entities 22-30. This may occur as a result of a malfunction of the transmitter 12-20 or as a result of operator incapacitation. A malfunction of the transmitter 12-20 is indicated by a loss of communication with that transmitter 12-20. A tripped tilt sensor may be indicative of operator incapacitation. If the tilt sensor on the transmitter 12-20 is tripped, then the transmitters 12-20 send a signal to the network entity 32 which, as a result, can switch the control authority to a different transmitter 12-20. Advantageously, such forced switch is made effective only after the network entity 32 has notified the transmitter 12-20 to which it intends to switch the control authority and after an acknowledgement signal has been received from that transmitter.

Yet another possible function that can be provided by the intelligence layer 36 is to provide a central emergency stop that brings all the locomotive entities 22-30 to a complete stop. The origin of the emergency stop command may vary. One possibility is to provide each transmitter 12-20 with the ability to send such emergency stop command via the respective communication link to the intelligence layer 36 that, in turn, will broadcast it to all of the locomotive entities 22-30. Another possibility is for the intelligence layer 36 to directly originate the emergency stop command without human intervention. For example, if the intelligence layer 36 observes a predetermined emergency situation, it sends an emergency stop command to each locomotive entity 22-30 via the respective communication link. This function can be refined to stopping only the locomotive entities 22-30 within a certain area or zone of the yard, not all the locomotive entities 22-30 in the yard. Once the area of the yard in which the emergency stop is to be implemented is determined, either as result of explicit human operator command or fully automatically, the intelligence layer 36 will determine which of the locomotive entities 22-30 are within that area. The position of each locomotive entities 22-30 can be determined as discussed earlier, such as by using a GPS receiver. At this point, the intelligence layer 36 will send only to the locomotive entities 22-30 in the area the emergency stop command.

A similar scheme can be used to command to every locomotive entities 22-30 or only to a sub-set of locomotive entities 22-30 in a specific area of the yard, a command to shut-down the engine. Such global shutdown command can be useful in the case of chemical spills or other emergencies.

Yet another possible function that can be performed by the intelligence layer 36 is to provide some maintenance function which is normally performed when the entire system is in a maintenance mode. In such maintenance mode, the transmitters 12-20 and locomotive entities 22-30 communicate with the network entity 32, however the transmitters 12-20 cannot control the respective locomotive entities 22-30. One specific maintenance function that the network entity 32 can perform is to make software upgrades of one or more devices with which it communicates, in particular the transmitters 12-20 and locomotive entities 22-30. Such software upgrade is performed by sending to the transmitters 12-20 and locomotive entities 22-30 the necessary software load over the respective RF communication links such that the new software can be installed locally.

Although various embodiments have been illustrated, this was for the purpose of describing, but not limiting, the invention. Various modifications will become apparent to those skilled in the art and are within the scope of this invention, which is defined more particularly by the attached claims.

1) A network entity for remotely controlling a plurality of locomotive entities, comprising:
a) a communication layer for communicating simultaneously via a set of RF communication links with respective remote transmitters and respective locomotive entities;
b) an intelligence layer communicating with said communication layer for processing data derived from signals received by said communication layer from the RF communication links.

2) A network entity as defined in claim 1, wherein said intelligence layer is operative to process a command contained in a signal received from a first transmitter and destined to a first locomotive entity to produce a modified command.

3) A network entity as defined in claim 2, wherein said intelligence layer is operative to transmit the modified command to said communication layer such that said communication layer can send a signal containing the modified command to the first locomotive entity.

4) A network entity as defined in claim 3, wherein said intelligence layer is operative to produce a modified command at least partially on the basis of information other than information conveyed in the signal received from the first transmitter.

5) A network entity as defined in claim 4, wherein the information other than the information conveyed in the signal received from the first transmitter is derived from a signal sent to said communication layer from a second transmitter.

6) A network entity as defined in claim 5, wherein the signal received by said communication layer from the second transmitter contains commands destined to a second locomotive entity of said plurality of locomotive entities.

7) A network entity as defined in claim 6, wherein the modified command directs the first locomotive to reduce speed.

8) A network entity as defined in claim 6, wherein the modified command directs the first locomotive to accelerate.

9) A network entity as defined in claim 1, wherein said communication layer is operative to create a log of events relating to operations of the plurality of locomotive entities derived from information contained in signals sent to said communication layer via the RF communication links.

10) A network entity as defined in claim 1, wherein said intelligence layer is operative to sense the presence in a signal received by said communication layer from a transmitter, an ancillary command directed to an ancillary device distinct from any one of the locomotive entities, the ancillary device command directing the ancillary device to perform a certain action.

11) A network entity as defined in claim 10, wherein said communication layer communicates with the ancillary device, said intelligence layer being operative to direct the ancillary device command to the ancillary device via said communication layer.

12) A network entity as defined in claim 11, wherein the intelligence layer includes an arbitration function for resolving conflicting ancillary device commands for the ancillary device sent from different transmitters via respective RF communication links.

13) A network entity as defined in claim 12, wherein the ancillary device is a railroad switch.

14) A network entity as defined in claim 1, wherein said intelligence layer is operative to sense presence in a signal received by said communication layer from a transmitter a media signal.

15) A network entity as defined in claim 14, wherein said intelligence layer includes a switching function for passing a media signal sent from a first transmitter to said communication layer via a first RF communication link at least to a second transmitter via a second communication link of said plurality of communication links.

16) A network entity as defined in claim 15, wherein the media signal includes address information identifying the second transmitter, said switching function switching the media signal to the second transmitter on the basis of the address information.

17) A network entity as defined in claim 16, wherein the media signal includes address information identifying a set of transmitters excluding the first transmitter, said switching function switching the media signal to the transmitters in the set on the basis of the address information.

18) A network entity as defined in claim 16, wherein the media signal includes audio information.

19) A network entity as defined in claim 16, wherein the media signal includes video information.

20) A network entity as defined in claim 1, wherein said intelligence includes a transmitter selector function to assign which transmitter in a set of transmitters will have authority to control a first locomotive entity, said transmitter selector operative to assign one of at least two modes of operation, namely a controlling mode and a non-controlling mode, said transmitter selector being operative to reject commands issued by a transmitter to which has been assigned a non-controlling mode and send to the first locomotive entity via said communication layer a command issued from a transmitter to which has been assigned a controlling mode.

21) A network entity as defined in claim 20 wherein said transmitter selector has the ability to discriminate different commands sent by the transmitters in the set.

22) A network entity as defined in claim 20, wherein said transmitter selector is operative to reject a command directing the first locomotive entity to move issued by a transmitter to which has been assigned a non-controlling mode.

23) A network entity as defined in claim 21, wherein said transmitter selector is operative to accept a command directing the first locomotive entity to brake from a transmitter having a non-controlling mode, and transmits the command to the first locomotive entity via said communication layer.

24) A network entity as defined in claim 23, wherein said transmitter selector is operative to send information to the transmitters of the set via respective RF communication channels indicating the operative modes assigned to the respective transmitters in the set.

25) A network entity for remotely controlling a plurality of locomotive entities, comprising:
a) a communication layer for communicating simultaneously via a set of RF communication links with respective remote transmitters and respective locomotive entities;
b) an intelligence layer communicating with said communication layer, said intelligence layer being capable to acquire at least a first and a second mode of operation, in the first mode of operation said intelligence layer allowing commands issued from the transmitters and conveyed via respective RF communication links to be transmitted to the respective locomotive entities via respective RF communication links, in the second mode of operation, said intelligence layer being operative to send to one or more transmitters via respective RF communication links data to allow the one or more transmitters to perform a software upgrade.

26) A network entity as defined in claim 25, wherein in said second mode of operation said intelligence layer being operative to send to one or more locomotive entities via respective RF communication links data to allow the one or more transmitters to perform a software upgrade.

27) A network entity as defined in claim 25, wherein the data to allow the one or more transmitters to perform a software upgrade includes a software load.
